(19) United States
(12) Patent Application Publication
(10) Pub. No.: US 2013/0222408 A1
(43) Pub. Date: Aug. 29, 2013

(54) COLOR MAPPING INTERPOLATION BASED ON LIGHTING CONDITIONS

(71) Applicants: Jeho Lee, Palo Alto, CA (US); Manu Parmar, Sunnyvale, CA (US)

(72) Inventors: Jeho Lee, Palo Alto, CA (US); Manu Parmar, Sunnyvale, CA (US)

(73) Assignee: QUALCOMM MEMS TECHNOLOGIES, INC., San Diego, CA (US)

(21) Appl. No.: 13/543,633

(22) Filed: Jul. 6, 2012

Related U.S. Application Data
(60) Provisional application No. 61/603,884, filed on Feb. 27, 2012.

(51) Int. Cl. G09G 5/02

(52) U.S. Cl. 345/589

(57) ABSTRACT

This disclosure provides systems, methods and apparatus, including computer programs encoded on computer storage media, for performing color mapping in a display device. The display device can include a plurality of stored color mappings that are used to convert input digital color images into the display device's color space. Each of the stored color mappings can correspond to a distinct lighting environment. The display device can detect its lighting environment and then combine two or more of the stored color mappings based on the detected lighting environment. For example, the display device may calculate an interpolated color mapping from two or more of the stored color mappings using interpolation weights that are based on the detected lighting conditions. The display device can then convert the input image using the composite color mapping, and display the image.

### CROSS-REFERENCE TO RELATED APPLICATIONS

This disclosure claims priority to U.S. Provisional Patent Application No. 61/603,884, filed Feb. 27, 2012, and entitled “COLOR MAPPING INTERPOLATION BASED ON LIGHTING CONDITIONS.” The disclosure of the prior application is considered part of this disclosure, and is incorporated by reference in its entirety.

### TECHNICAL FIELD

This disclosure relates to color image processing in display systems, including, for example, color mapping of source color image information to target color image information in displays in various lighting environments.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

Various types of displays, including those made up of interferometric modulators, may implement color mapping techniques to reduce color distortion when displaying a color image. In digital image processing, color spaces are used to define images that are to be displayed on a display device. An RGB color space, for example, is a color space that includes the gamut of colors that can be created by mixing three chromaticities of red (R), green (G), and blue (B) primary colors (or “primaries”) in different amounts. The specific gamut of colors included within a color space depends upon the specific chromaticities of the primaries for the color space.

Different display devices have different primaries, owing to differences in their designs and physical principles of operation. Since different display devices use different primaries, each type of display device may have a unique gamut of colors that it is capable of displaying. Moreover, a given color (for example, a particular hue of red) may be represented by different mixtures of the primaries of one type of display device as compared to another that uses different primaries. For example, an image pixel with primary values (R=0.8, G=0.2, B=0.1) on one display device would not have the same chromaticity on another display device that uses different primaries. Accordingly, in order to reduce the amount of color distortion introduced when displaying a color image, display devices may include the capability to transform an image from a device-independent color space (for example, the widely-used sRGB color space), in which the image is defined, to an output image in a device-dependent color space in which the image is displayed to a viewer. This color mapping process may be used to help compensate for differences between the primaries used in the device-independent color space as compared to those used in the device-dependent color space in order to allow the display device to accurately reproduce the image without unduly distorting the colors of the image.

### SUMMARY

The systems, methods and devices of the disclosure each have several innovative aspects, no single one of which is solely responsible for the desirable attributes disclosed herein.

Some innovative aspects of the subject matter described in this disclosure can be implemented in a device with a display, an ambient light level sensor configured to measure the level of ambient light, and a built-in light source configured to provide light for viewing the display. The device can also include a processor configured to receive first color image information and to receive at least a first input that is indicative of the level of ambient light or the level of light output by the built-in light source. The processor can determine a combined color mapping for rendering colors on the display. The combined color mapping can be based, at least in part, upon the first input, a first color mapping, and a second color mapping. The first color mapping can be associated with a first lighting environment and the second color mapping can be associated with a second lighting environment that is different from the first lighting environment. The processor can convert the first color image information to second color image information that is to be displayed upon the display using the combined color mapping. The first color mapping can be associated with the level of ambient light being above a first threshold and the second color mapping can be associated with the level of ambient light being below a second threshold that is lower than the first threshold.

Some innovative aspects of the subject matter described in this disclosure can also be implemented in a method for controlling color mapping in a reflective display. The method can include receiving first color image information and receiving at least a first input that is indicative of a characteristic of the lighting environment of the reflective display. The method can also include determining a combined color mapping for rendering colors on the reflective display. The combined color mapping can be based, at least in part, upon the first input, a first color mapping, and a second color mapping. The first color mapping can be associated with a first lighting environment and the second color mapping can be associated with a second lighting environment that is different from the first lighting environment. The method can also include converting the first color image information to second color image information that is to be displayed upon the reflective display using the combined color mapping.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9 is a flowchart that illustrates certain implementations of a color mapping method in a display device.

FIG. 10 is a table that illustrates an example implementation of a three-dimensional lookup table (3D LUT) that can be used in a color mapping process in a display device.

FIG. 11 is a table that illustrates an example implementation of color mapping interpolation weights for combining color maps that correspond to distinct lighting conditions so as to create a combined color map that corresponds to a mixed lighting condition.

FIG. 12 is a block diagram of an example implementation of a module for performing color mapping in a display device.

FIG. 13 is a block diagram of an example implementation of a module for combining color maps that correspond to distinct lighting conditions so as to create a combined color map the corresponds to a mixed lighting condition.

FIGS. 14A and 14B show examples of system block diagrams illustrating a display device that includes a plurality of interferometric modulators and that performs color mapping interpolation based on lighting conditions.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, and electronic test equipment. Thus, the teachings are not intended to be limited to the implementations depicted solely in the Figures, but instead have wide applicability as will be readily apparent to a person having ordinary skill in the art.

Display devices described herein can include a plurality of stored color mappings that are used to convert input digital color images into the display device's color space. Each of the stored color mappings can correspond to a distinct lighting environment. For example, the stored color mappings may be designed for use when the display device is being viewed under different combinations of ambient light (e.g., direct sunlight, fluorescent lighting, incandescent lighting, etc.) and light from a built-in light source. The display device can detect its lighting environment and then combine two or more of the stored color mappings based on the detected lighting environment. For example, the display device may calculate an interpolated color mapping from two or more of the stored color mappings using interpolation weights that are based on the detected lighting conditions. The display device can then convert the input image using the composite color mapping, and display the image.

Particular implementations of the devices and methods described in this disclosure can be implemented to realize various potential advantages. For example, the display devices described herein can adapt their color mapping schemes to suit their current lighting environment. This adaptive color processing can reduce color distortion in images being viewed on the display device under a wide variety of lighting conditions. In this way, a more consistent viewing experience can be provided to a user.

An example of a suitable MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

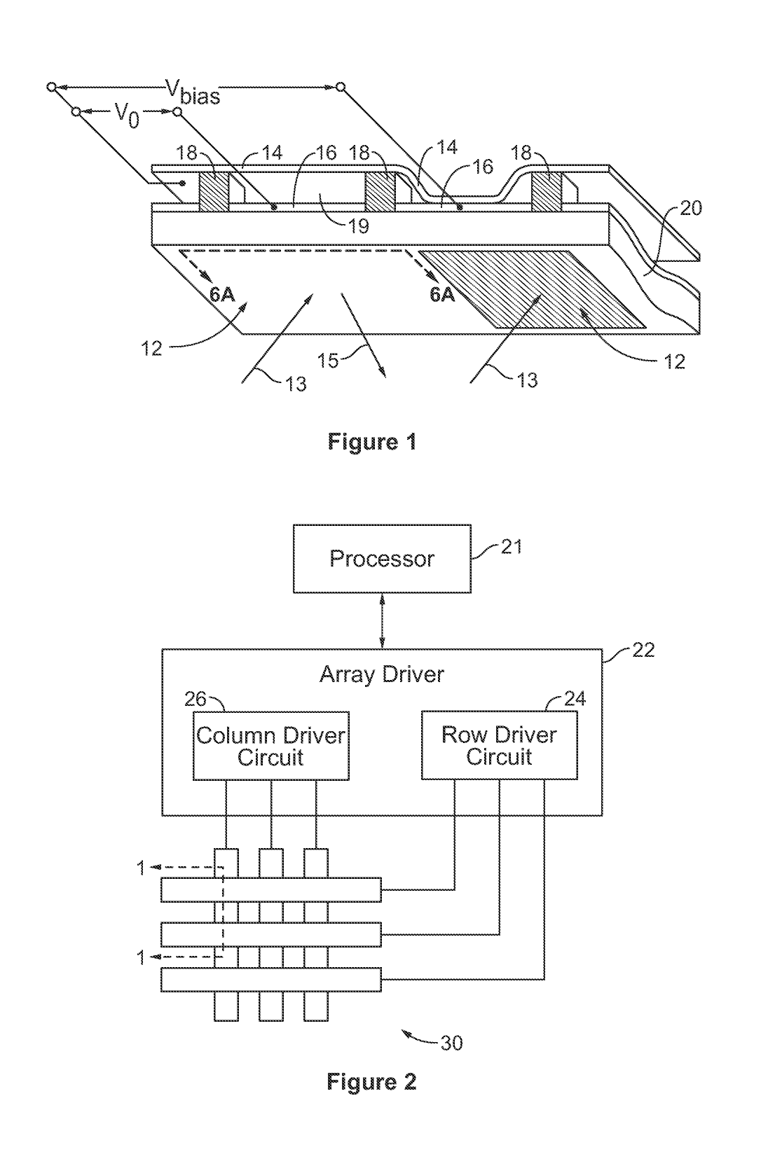

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when actuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V0 applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage Vbias applied across the IMOD 12 on the right is sufficient to maintain the movable reflective layer 14 in the actuated position.

In FIG. 1, the reflective properties of pixels 12 are generally illustrated with arrows indicating light 13 incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

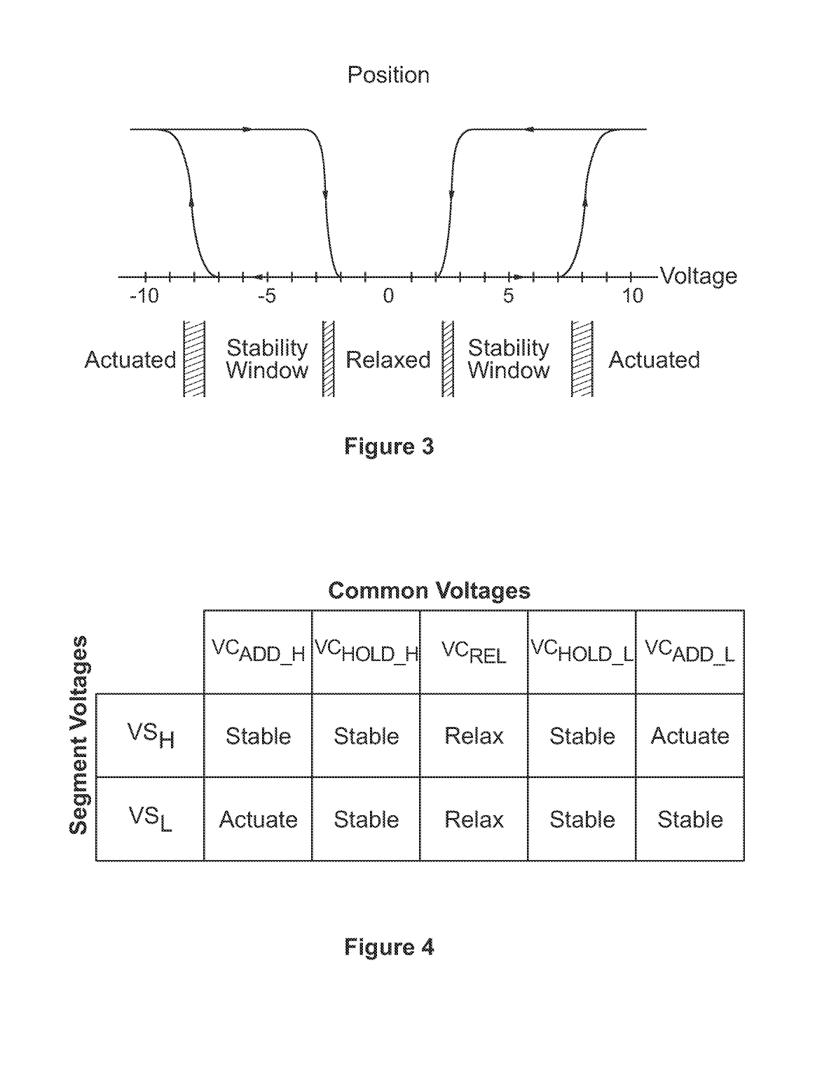

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

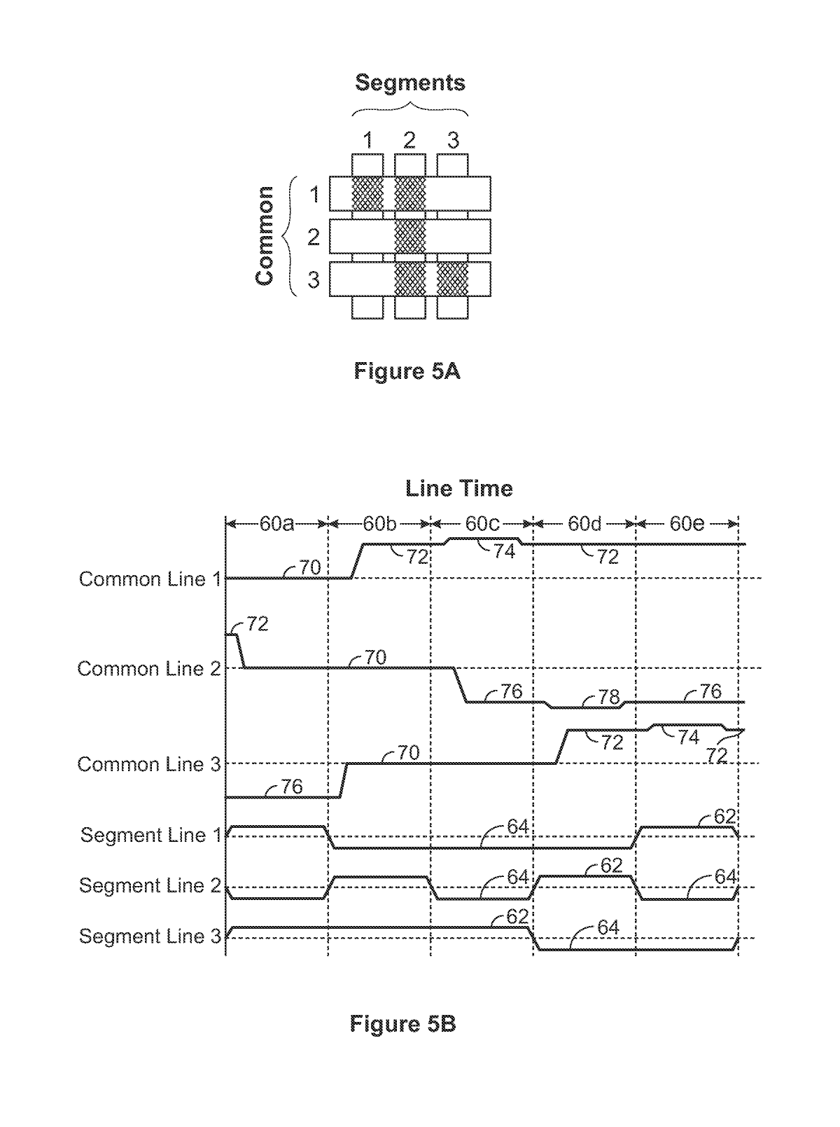

As illustrated in FIG. 4 (as well as in the timing diagram shown in FIG. 5B), when a release voltage VCREL is applied along a common line, all interferometric modulator elements along the common line will be placed in a relaxed state, alternatively referred to as a released or unactuated state, regardless of the voltage applied along the segment lines, i.e., high segment voltage VSH and low segment voltage VSL. In particular, when the release voltage VCREL is applied along a common line, the potential voltage across the modulator (alternatively referred to as a pixel voltage) is within the relaxation window (see FIG. 3, also referred to as a release window) both when the high segment voltage VSH and the low segment voltage VSL are applied along the corresponding segment line for that pixel.

When a hold voltage is applied on a common line, such as a high hold voltage VCHOLD_H or a low hold voltage VCHOLD_L, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VSH and the low segment voltage VSL are applied along the corresponding segment line. Thus, the segment voltage swing, i.e., the difference between the high VSH and low segment voltage VSL, is less than the width of either the positive or the negative stability window.

When an addressing, or actuation, voltage is applied on a common line, such as a high addressing voltage VCADD_H or a low addressing voltage VCADD_L, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VCADD_H is applied along the common line, application of the high segment voltage VSH can cause a modulator to remain in its current position, while application of the low segment voltage VSL can cause actuation of the modulator. As a corollary, the effect of the segment voltages can be the opposite when a low addressing voltage VCADD_L is applied, with high segment voltage VSH causing actuation of the modulator, and low segment voltage VSL having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VCREL-relax and VCHOLD_L-stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

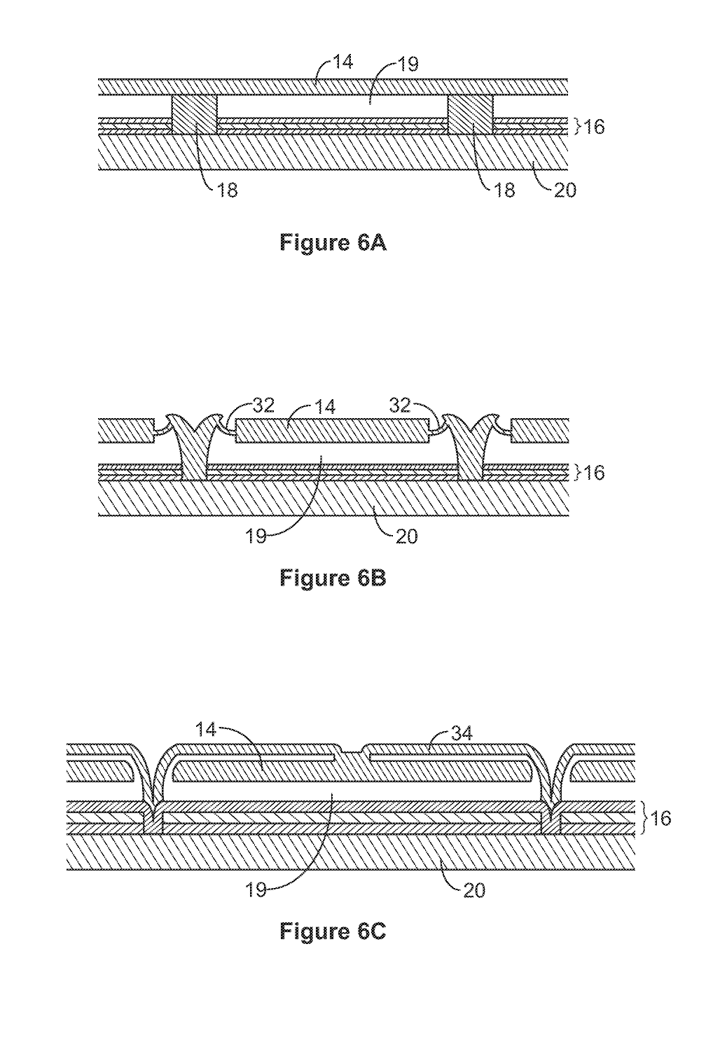

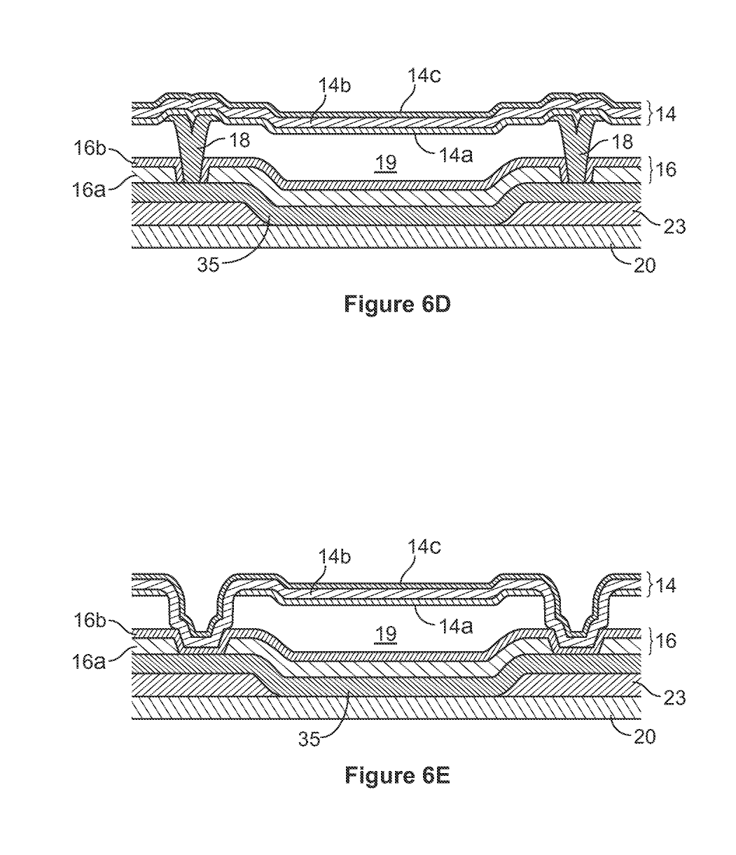

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO2). In some implementations, the support layer 14b can be a stack of layers, such as, for example, a SiO2/SiON/SiO2 tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoride (CF4) and/or oxygen (O2) for the MoCr and SiO2 layers and chlorine (Cl2) and/or boron trichloride (BCl3) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

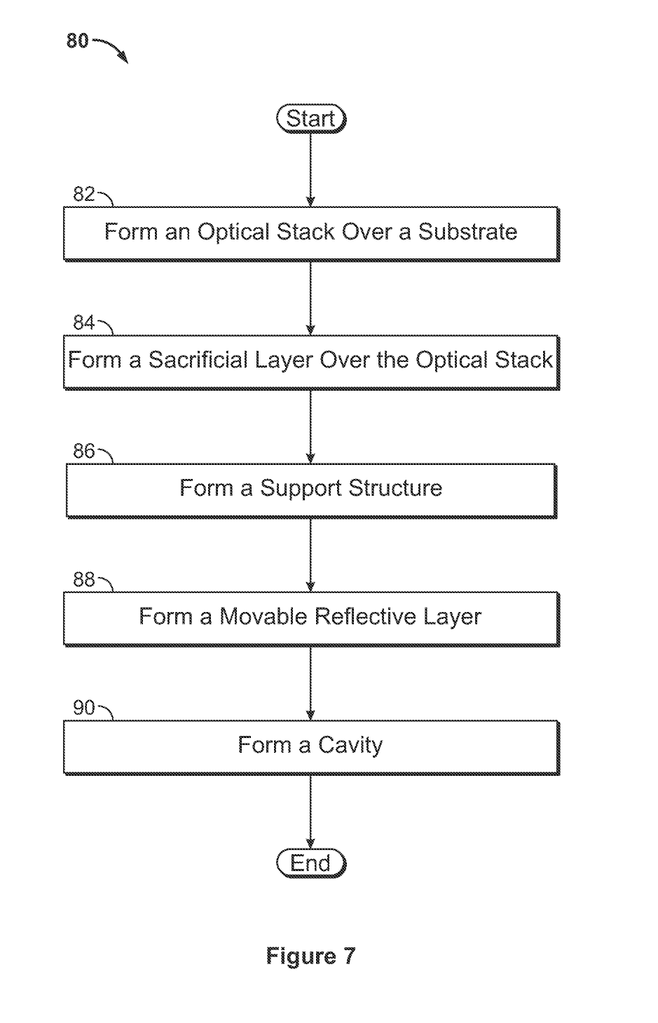

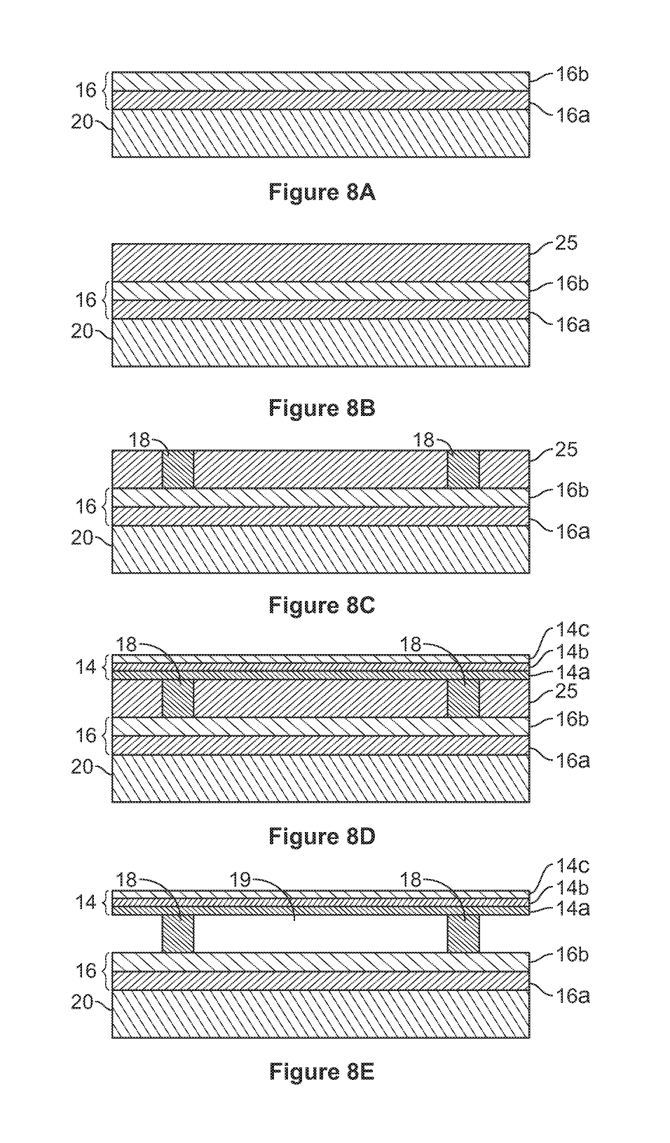

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF2)-etchable material such as molybdenum (Mo) or amorphous silicon (a-Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF2 for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

As discussed herein, in digital image processing, color spaces are used to define images that are to be displayed on a display device. An RGB color space, for example, is a color space that includes the gamut of colors that can be created by mixing three chromaticities of red (R), green (G), and blue (B) primary colors (or “primaries”) in different amounts. The specific gamut of colors included within a color space depends upon the specific chromaticities of the primaries for the color space.

Different display devices have different primaries, owing to differences in their designs and physical principles of operation. Since different display devices use different primaries, each type of display device may have a unique gamut of colors that it is capable of displaying. Moreover, a given color (for example, a particular hue of red) may be represented by different mixtures of the primaries of one type of display device as compared to another that uses different primaries. For example, an image pixel with primary values (R=0.8, G=0.2, B=0.1) on one display device would not have the same chromaticity on another display device that uses different primaries. Accordingly, in order to reduce the amount of color distortion introduced when displaying a color image, display devices may include the capability to transform source color image information, such as an image from a device-independent color space (for example, the widely-used sRGB color space), in which the image is defined, to target color image information, such as an output image in a device-dependent color space in which the image is displayed to a viewer. This color mapping process may be used to help compensate for differences between the primaries used in the device-independent color space as compared to those used in the device-dependent color space in order to allow the display device to accurately reproduce the image without unduly distorting the colors of the image.

Reflective display devices are one type of display device that can use color mapping techniques to accurately reproduce digital images. Unlike other types of display devices (for example, LCD display devices) that require the constant operation of a built-in backlight in order to display an image, reflective display devices can produce a viewable image using available ambient light (e.g., direct sunlight or artificial light indoors) or a built-in front light, depending upon the ambient lighting conditions. Reflective display devices include, for example, interferometric modulator (IMOD) display devices. Reflective display devices are gaining popularity in mobile electronic devices such as mobile telephones and electronic reading devices (for example, e-readers). This increased popularity is caused, in part, by their sunlight readability and relatively low power consumption. The low power consumption is due to the fact that reflective display devices do not require supplemental back lighting much of the time. However, under dark ambient lighting conditions, supplemental illumination can be provided by a front light that is positioned between the viewer and the display. For example, the front light can include a light source (for example, one or more light emitting diodes) and a light guide that receives light from the light source and directs the light onto the reflective display.

The fact that reflective display devices can operate using different light sources (e.g., ambient sunlight, ambient fluorescent light, ambient incandescent light, or light from a built-in front light), and combinations thereof, results in certain challenges with respect to color reproduction. This is due to the fact that the measured color output of the reflective display device is the result of both the wavelength-dependent power distribution of the display illuminant and the wavelength-dependent reflectance function of the display device. For instance, an object that primarily reflects light in the yellow region of the visible spectrum will appear red under a predominantly red light and green under a predominantly green light. In addition to the change in color appearance, viewing objects under different illuminants can cause another color-related issue: objects that appear distinct under one light can appear similar under another light. This effect is called metamerism and such colors/objects are called metamers. In general, indoor office lights are fluorescent lamps which produce an irregular or peaky spectral emittance curve. It is quite common that two materials under fluorescent light do not match, even though they are a metameric match to the daylight source (for example, International Commission on Illumination daylight illuminant D65) with a nearly flat or smooth emittance curve.

As already discussed, the primaries of one display device can vary from the primaries of a different type of display device. Moreover, the primaries of, for example, a single interferometric modulator reflective display can even change based upon the lighting environment because the color appearance of an image displayed on a reflective display device can depend on the spectral content of the illuminant. For example, if an image were optimized for viewing on a reflective display device under typical office lighting (for example, fluorescent light), then the image would have warmer hues (for example, a yellow tint) when viewed under daylight, and cooler hues (for example, a blue tint) when viewed with a front light that has strong energy at short wavelengths.

Therefore, the following disclosure describes different implementations of a color mapping process and device that can be used to help compensate for color distortion that may be apparent under different illuminants and/or different combinations of illuminants. Different lighting conditions can be grouped into various broadly-defined use cases, such as, for example, 1) outdoor, 2) indoor with some front light, and 3) predominantly front light. In various implementations, additional and/or different lighting conditions can be defined and used by the color mapping process.

In some implementations, the color mapping process can be used in a reflective display device to reduce color distortion of images viewed on the reflective display device in different lighting environments (for example, to make images viewed under various front light strengths appear more similar to images viewed without front light). For example, the disclosure describes a method and device for reducing shifts from a desired color appearance, across different combinations of levels and/or frequency spectra of front light and ambient illumination, by quantitatively adjusting the color rendering scheme to account for the contributions of the front light and the contributions of the ambient light. For example, a color mapping designed for use under operation of a front light can be quantitatively combined in varying degrees with color mappings designed for use under various ambient lighting conditions depending upon the strength and/or spectral content of the front light as compared to the amount and/or spectral content of ambient light.

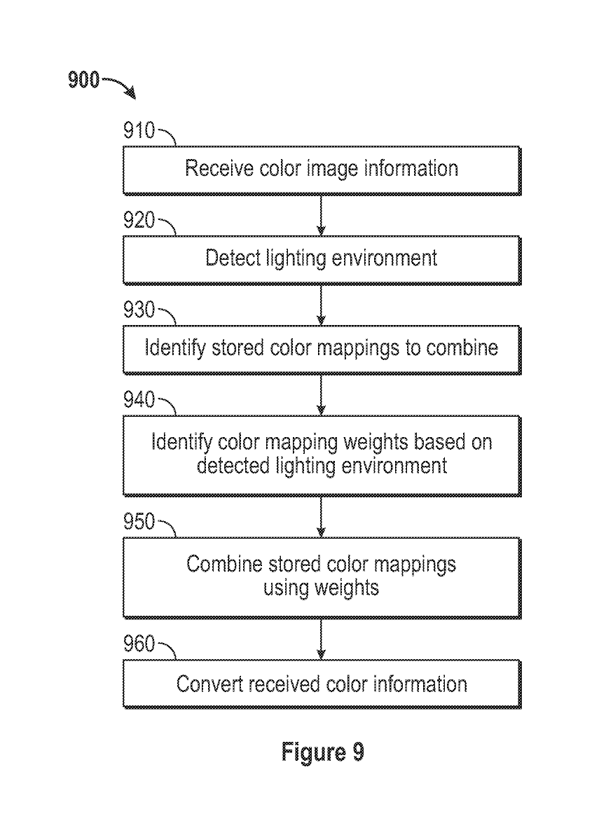

FIG. 9 is a flowchart that illustrates certain implementations of a color mapping method 900 in a display device. In some implementations, the method 900 begins with receiving color image information at block 910. The color image information can be, for example, a source digital color image. The source digital color image can be defined, for example, in a device-independent color space. In some implementations, the device-independent color space is the sRGB color space. The color mapping method 900 may continue at block 920, where the lighting environment of the display device is detected. The lighting environment can include, for example, information about the level and/or spectral content of ambient light that is incident upon an ambient light detector included with the display device. The ambient light detector is a photodiode in some implementations. The lighting environment can also include, for example, information about the level and/or spectral content of light from a built-in light source of the display device. The built-in light source can be, for example, a front light assembly for illuminating display elements of a reflective display.

At block 930, the color mapping method identifies two or more stored color mappings to combine. The stored color mappings can each correspond to, for example, a distinct lighting condition. For example, as discussed more fully herein, one of the stored color mappings may be designed for a common outdoor lighting environment. Such a color mapping can be designed, based upon the primaries of the display device when viewed in the outdoor lighting environment, to reduce or eliminate color distortion when converting a device-independent digital color source image to a device-dependent digital color target image. Additionally, and/or alternatively, one of the stored color mappings may be designed for use when the built-in light source is operating, for example under dark ambient lighting conditions. In such a case, the color mapping can be designed, based upon the primaries of the display device when viewed using the built-in light source, to reduce or eliminate color distortion when converting a device-independent digital color source image to a device-dependent digital color target image. Further, one of the stored color mappings may be designed for use under some combination of ambient light and light from the built-in light source. For example, in such a case, the color mapping can be designed to reduce or eliminate color distortion when performing color mapping in a lighting environment in which approximately half of the light for viewing the display device is ambient light and approximately half is light from the built-in light source. Again, such a color mapping can be designed based upon the primaries of the display device under such lighting conditions. Notwithstanding the foregoing options for stored color mappings, many other different stored color mappings could also be used.

The color mapping method 900 may continue at block 940, where color mapping weights are identified based on, for example, the lighting environment detected at block 920. In some implementations, the color mapping weights are coefficients that are used to quantitatively combine at least two of the stored color mappings identified in block 930.

At block 950, the color mapping method 900 combines the selected stored color mappings using the color mapping weights identified in block 940. In some implementations, the combination of stored color mappings is a quantitative combination, such as an interpolated color mapping. For example, the combined color mapping can be linearly interpolated from two or more of the stored color mappings from block 930, which each correspond to a distinct lighting environment, by using the color mapping weights identified in block 940, which are identified based upon the detected lighting environment.

Finally, at block 960, the color mapping method 900 converts the color image information received at block 910 using the combined color mapping from block 950. For example, a source digital color image can be converted to a target digital color image that is to be displayed on the display device. Various aspects of this method will now be described in greater detail.

In some implementations, the color mapping method 900 is made adaptive in order to find improved color mappings for displays depending on, for example, the current viewing conditions. A color mapping can refer to, for example, a table or function which relates one color space to another. A color mapping can be used to convert an image from one color space to another by, for example, transforming the colors of a source image to the colors of an output image that is to be displayed on a display device. The color mapping can be embodied in, for example, a multi-dimensional (e.g., three dimensional or 3D) lookup table (LUT). The 3D LUTs employed in color mapping are generally built for transformation between device-independent color spaces (for example, the widely-used sRGB color space) and device-dependent color spaces (which depend upon the primaries of the display device). In some implementations, a 3D LUT-based color mapping subdivides an RGB input color space into a number of vertices, where each vertex corresponds to a particular combination of the R, G, and B primaries (i.e., a particular color). In some implementations, the 3D LUT-based color mapping subdivides the RGB color space into (n×n×n)=n³ vertices, where n=9, n=17, or n=33, for example (other values can also be used for n). Then, the transformation between the input and output color spaces is defined on these points in the form of a 3D LUT.

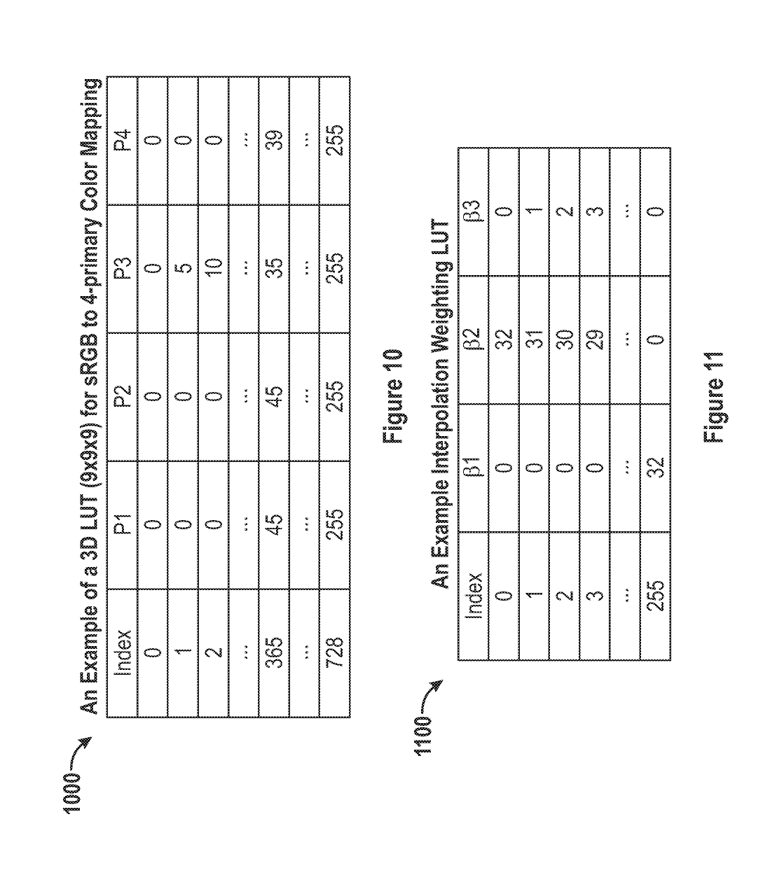

FIG. 10 is a table 1000 that illustrates an example implementation of a three-dimensional lookup table (3D LUT) that can be used in a color mapping method in a display device. Specifically, the table 1000 shows an example of a 3D LUT (9×9×9) that transforms sRGB input colors to a 4-primary color space for a display device. Here, P1, P2, P3, P4 indicate the primaries of the display device. Note that a 3D LUT can also be used for three-primary or other multi-primary displays without any loss of generality. In this example, since the 3D LUT is (9×9×9), there are 9³=729 different colors, which are each represented by an index value from 0 to 728. Each index, or color, is then associated in the table with, or mapped to, a value for each of the primaries in the output color space. The particular mappings depend, of course, upon the primaries being used.

As discussed above, for a reflective display device such as an interferometric modulator display device, there can, in some implementations, be three or more ranges of viewing conditions that can affect the color appearance of the display: 1) outdoor, 2) indoor with some front light, and 3) predominantly front light. In order to reduce color distortion when shifting from one of these viewing conditions to another, a distinct LUT for each viewing condition can be created and stored in a computer-readable storage medium (for example, read-only memory in the device). Then, depending upon sensory inputs, such as the ambient light strength and the front light strength, the display device can interpolate (for example, linearly) between the three stored LUTs to create a color mapping LUT for any given viewing condition, regardless of where the viewing condition falls within the ranges of defined viewing conditions.

For example, the “outdoor” viewing condition can be defined by the ambient light level being above a certain upper ambient threshold and the front light being off or its output being below a certain lower front light threshold. The “indoor with some front light” viewing condition can be defined by the ambient light level being between the upper ambient threshold and a lower ambient threshold, while the front light output is between the lower front light threshold and an upper front light threshold. The “predominantly front light” viewing condition can be defined by the ambient light level being below the lower threshold, while the front light output is above the upper front light threshold.

A 3D color mapping LUT can be defined and stored for a representative point in each of the three defined ranges of viewing conditions. For example, the color mapping LUT for the “outdoor” viewing condition could be defined for an ambient light value that corresponds to a sunny day and the front light being completely off. The color mapping LUT for the “indoor with some front light” viewing condition could be defined, for example, for an ambient light value that corresponds to typical office lighting and the front light being on at about half power. The color mapping LUT for the “predominantly front light” viewing condition could be defined for an ambient light value that corresponds to a dark room and the front light being on at about full power. As discussed herein, the reflective display device can include sensors for determining the strength of both the ambient light and the front light. Once these values are determined, a color mapping LUT for the particular detected conditions can be determined by selecting a LUT from memory that is judged to be the most suitable for the detected lighting conditions, or a new color mapping LUT can be calculated by interpolating between the three stored LUTs. In other implementations, a greater or lesser number of stored LUTs, each corresponding to a viewing condition, can be used.

In the case of a 9×9×9 3D LUT, a new color mapping LUT can be derived from linear interpolation by Equation (1):

$$[ \begin{matrix}new P {1}_{i} \\ new P {2}_{i} \\ new P {3}_{i} \\ new P {4}_{i}\end{matrix} ] = β 1 [ \begin{matrix}P 1 {outdoor}_{i} \\ P 2 {outdoor}_{i} \\ P 3 {outdoor}_{i} \\ P 4 {outdoor}_{i}\end{matrix} ] + β 2 [ \begin{matrix}P 1 {indoor}_{i} \\ P 2 {indoor}_{i} \\ P 3 {indoor}_{i} \\ P 4 {indoor}_{i}\end{matrix} ] + β 3 [ \begin{matrix}P 1 {frontlight}_{i} \\ P 2 {frontlight}_{i} \\ P 3 {frontlight}_{i} \\ P 4 {frontlight}_{i}\end{matrix} ] \qquad ( 1 )$$

for i=0, 1, 2, . . . , 728, where β1, β2, and β3 are the interpolation weights for each of the defined viewing condition LUTs (e.g., “outdoor,” “indoor with some front light,” and “predominantly front light” in this example).

FIG. 11 is a table 1100 that illustrates an example implementation of color mapping interpolation weights for combining color maps that correspond to distinct lighting conditions so as to create a combined color map that corresponds to a mixed lighting condition. The interpolation weights (β1, β2, and β3) can be determined based on the output of an ambient light sensor and the strength of the front light. If the measured ambient light value and the front light value can each be, for example, one of 16 possibilities, then there will be 256 unique combinations of ambient light and front light values. Each of these 256 combinations can be indexed and then mapped to corresponding interpolation weights in a LUT, as illustrated in FIG. 11.

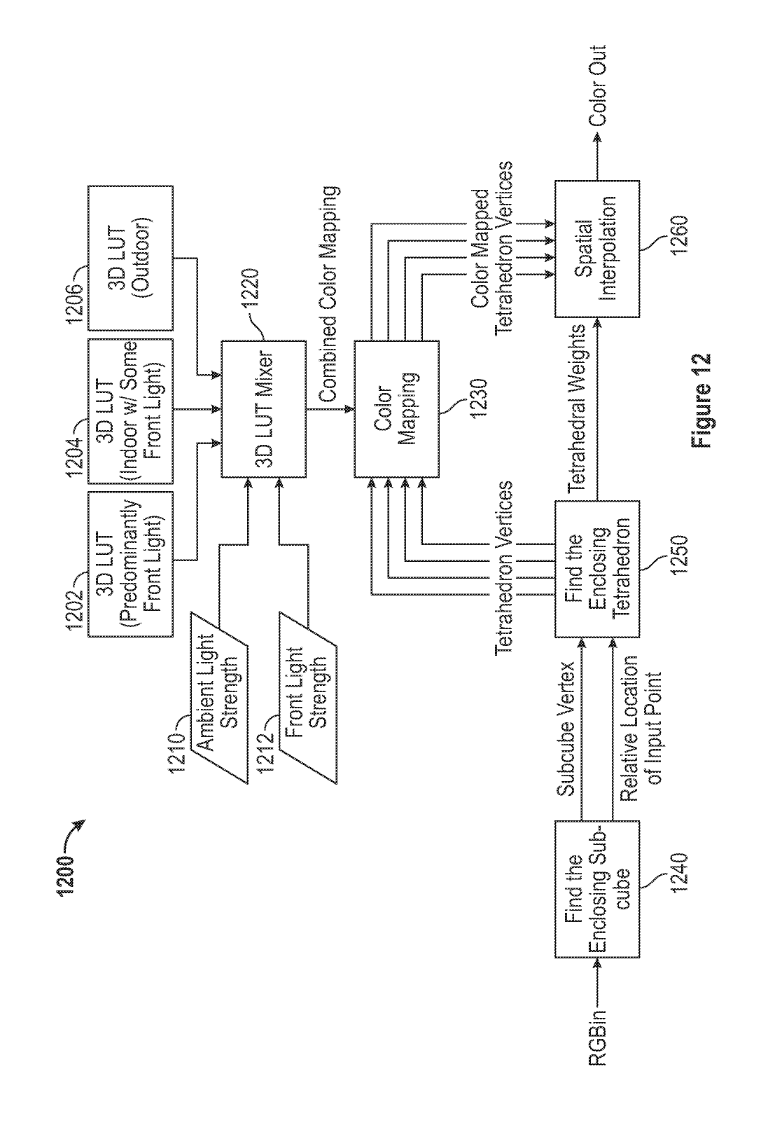

FIG. 12 is a block diagram 1200 of an example implementation of a module for performing color mapping in a display device. The block diagram 1200 illustrates the technique described herein to determine new interpolated color mapping LUTs based on the detected lighting conditions. For example, the lighting conditions are detected in block 1210, which indicates the ambient light strength, and in block 1212, which indicates the front light strength. In some implementations, the ambient light sensor may provide both the lighting intensity level as well as spectral, or relative spectral, content of the ambient light, such as an RGB sensor which may provide relative intensities of red, green, and blue light in the detected ambient light. Such spectral data can also be used, in addition to the light intensity data, to determine the interpolation weights (β1, β2, and β3).

The ambient light strength and front light strength values are fed into the 3D LUT Mixer block 1220, which can implement, for example, Equation (1). Of course, in order to perform the 3D LUT interpolation, the 3D LUT Mixer block 1220 also receives the three stored 3D color mapping LUTs, which are defined for certain representative lighting conditions. As discussed herein, in some implementations, these include the “outdoor” LUT 1206, the “indoor with some front light” LUT 1204, and the “predominantly front light” LUT 1202. The 3D LUT Mixer block 1220 outputs a new combined color mapping based on the detected lighting conditions. The combined color mapping is then used in the Color Mapping block 1230, where lookup operations are performed to map colors from the input color space to the output color space.

In some implementations, the sensor input regarding the lighting environment of the device can be used to determine a value that is indicative of the color temperature of the lighting environment. In such implementations, the stored color mappings could include color mappings designed for use in lighting environments with white points of different color temperatures. For example, a color mapping for a first color temperature (for example, relatively warm white light) can be stored along with a color mapping for a second color temperature (for example, relatively cool white light). Then, a combined color mapping can be obtained by interpolating between two or more stored color mappings which are designed for different color temperatures.

The technique described herein to determine new interpolated color mapping LUTs based on the detected lighting conditions can be used in combination with spatial interpolation techniques to interpolate between vertices that are defined in the color mapping LUT. As mentioned above, a color mapping LUT typically only defines color mappings at the vertex points of the color spaces. However, it is often desirable to determine color mappings for points in between the defined vertices. In these cases, a tetrahedral 3D spatial interpolation technique can be used to spatially interpolate color mappings between vertices.

The block diagram 1200 also illustrates an example spatial interpolation method. First, an RGB input value is received. At block 1240, the sub-cube that encloses the input RGB value is determined. This block outputs both the vertex value corresponding to the identified sub-cube, as well as the relative location of the input RGB value within the sub-cube. The sub-cube can be made up of six tetrahedra. In block 1250, it is determined which of the six tetrahedra encloses the RGB input point. Once the enclosing tetrahedron is identified, block 1250 outputs the four vertices of the enclosing tetrahedron. These four vertices are color mapped to the output color space in block 1230. Block 1250 also outputs tetrahedral weights, which indicate how the color mapped tetrahedron vertices that are output from the color mapping block 1230 should be spatially interpolated by block 1260. Spatial interpolation of the four tetrahedron vertices in block 1260 yields the final output color value.

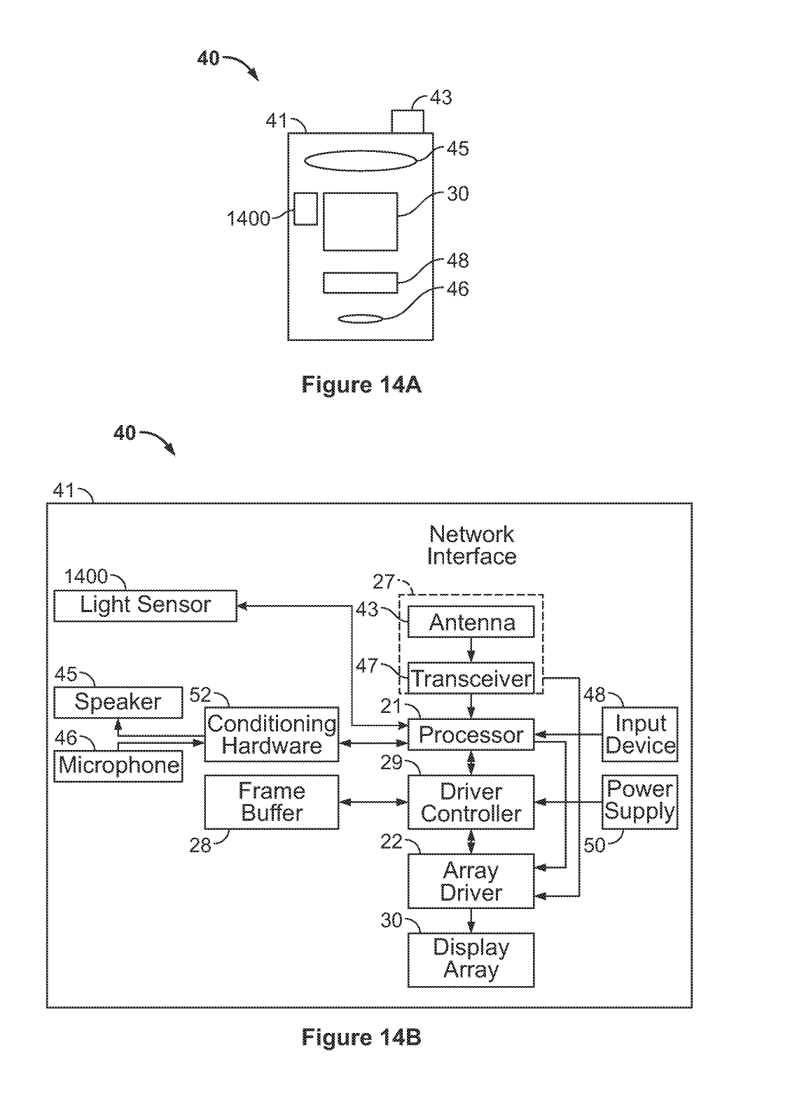

The interpolation process can be implemented via an appropriate combination of hardware, software, and/or firmware in a device. These can include one or more application-specific integrated circuits or specially-programmed computing devices that are configured to implement the interpolation process. For example, as further discussed with reference to FIGS. 14A and 14B, a processor 21, a driver controller 29, or some other electronic circuitry can be used to implement the interpolation process in various devices.

In some implementations, generating the combined 3D LUT may be performed periodically (for example, once every several seconds, etc). In some implementations, a 3D LUT is computed based upon the current ambient light and front light inputs, and the 3D LUT is not updated unless a change is registered by the ambient light sensor that exceeds a certain threshold. Once the measurement of the ambient light sensor changes beyond the threshold, a new 3D LUT may then be computed based on the updated sensor measurement. Hence, the 3D LUT Mixer 1220 need not update the combined 3D LUT with each pixel, frame, or even image.

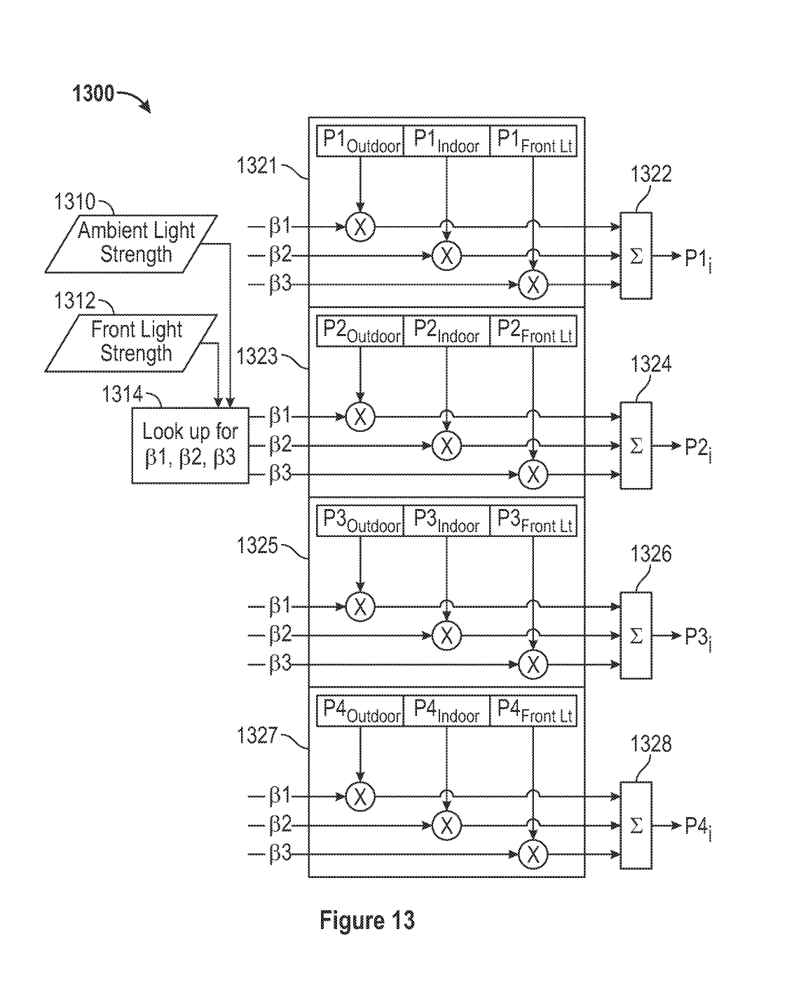

FIG. 13 is a block diagram 1300 of an example implementation of a module for combining color maps that correspond to distinct lighting conditions so as to create a combined color map that corresponds to a mixed lighting condition. Specifically, FIG. 13 illustrates an example hardware implementation of the 3D LUT Mixer 1220 and Equation (1). As illustrated, the ambient light strength 1310 and the front light strength 1312 are received as inputs and are used to look up interpolation weights (β1, β2, and β3) at block 1314. Then, in block 1321, the interpolation weights are respectively multiplied by the mapping values corresponding to the primary P1 from each of the stored predefined viewing condition 3D LUTs (i.e., “outdoor,” “indoor with some front light,” and “predominantly front light”). At block 1322, the weighted mapping values are summed and outputted as P1ᵢ. The same process is performed in blocks 1323 and 1324 for P2ᵢ, and in blocks 1325 and 1326 for P3ᵢ, and in blocks 1327 and 1328 for P4ᵢ.

Although the example LUT mixing process shown in FIG. 13 is described in terms of interpolating between three LUTs corresponding to “outdoor”, “indoor with some front light”, and “predominantly front light” conditions, respectively, any number (e.g., 2, 4, 5, 6, or more) of lighting conditions and corresponding LUTs can be used in other implementations. For example, three lighting conditions corresponding to “high”, “medium,” and “low” amounts of ambient light can be used. Further, in other implementations, the three (or other number) LUTs can be combined using mathematical or statistical techniques other than linear interpolation, such as nonlinear interpolation, spline interpolation, filtering, regression, and so forth.

The color mapping processes described herein may be implemented in any device that is configured to display an image, whether in motion (for example, video) or stationary (for example, still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (for example, e-readers), computer monitors, auto displays (for example, odometer display, etc.), cockpit controls and/or displays, camera view displays (for example, display of a rear view camera in a vehicle), electronic photographs, electronic billboards or outdoor signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, and electronic test equipment. Thus, the teachings are not intended to be limited to the implementations depicted solely in the figures, but instead have wide applicability as will be readily apparent to a person having ordinary skill in the art.

FIGS. 14A and 14B show examples of system block diagrams illustrating a display device 40 that includes a display 30 having a plurality of reflective display elements, such as a plurality of interferometric modulators, and that performs color mapping interpolation based on lighting conditions. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog IMOD display. The display 30 can be a reflective display. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein. The display device 40 may also include a source of supplemental lighting (not shown) configured to provide supplemental lighting to the display 30. For example, the source of supplemental lighting may include a front-light. The display device 40 may also include a sensor (or other electronic circuitry) configured to measure, sense, or determine the amount of supplemental light provided to the display 30. The device 40 can communicate information on the amount of supplemental light being used to illuminate the display 30 to the processor 21 for use with the color processing methods described herein. In some cases, the processor 21 may provide control information to a supplemental light device controller that adjusts the supplemental light source.

The components of the display device 40 are schematically illustrated in the example FIG. 14B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (for example, filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components. In some implementations, the processor 21 can be used (at least in part) to perform the color processing interpolation processes described herein.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22. In some implementations, the driver controller 29 can be used (at least in part) to perform the color processing interpolation processes described herein (as an alternative to or in a combination with the processor 21).

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays discussed herein. For example, the driver controller 29 can be a conventional display controller or a bi-stable display controller (for example, an IMOD controller). Additionally, the array driver 22 can be a conventional driver or a bi-stable display driver (for example, an IMOD display driver). Moreover, the display array 30 can be a conventional display array or a bi-stable display array (for example, a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The color mapping interpolation processes described herein can be implemented in any number of hardware and/or software components (for example, the processor 21).

The display device 40 can also include a light sensor 1400. The light sensor 1400 may include an ambient light sensor unit configured to measure ambient light conditions. In some implementations, the ambient light sensor may provide both the lighting intensity level as well as spectral, or relative spectral, content of the ambient light, such as an RGB sensor which may provide relative intensities of red, green, and blue light in the detected ambient light. The light sensor 1400 may also, or alternatively, include a front light sensor unit configured to measure the output of the front light. As an alternative to a front light sensor unit, the processor may be configured to determine the front light output from front light control circuitry, for example, by receiving information on how much power is being provided to the front light (e.g., high power, medium power, low power, or no power). In some implementations, the light sensor 1400 can be used to measure the amount of light (for example, ambient light) that is incident upon the display device 40. The light sensor 1400 may include one or more photodetectors or photodiodes. The light sensor 1400 can output one or more measurement signals to the processor 21, to be used by the color processing algorithms and methods described herein.

The various illustrative logic, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations may be depicted in the drawings or described in the text in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A device comprising:
a display;
a built-in light source configured to provide light for viewing the display; and
a processor configured to:
receive first color image information;
receive at least a first input that is indicative of a characteristic of the lighting environment of the display;
determine a combined color mapping for rendering colors on the display, wherein the combined color mapping is based, at least in part, upon the first input, a first color mapping, and a second color mapping, the first color mapping being associated with a first lighting environment and the second color mapping being associated with a second lighting environment that is different from the first lighting environment; and
convert the first color image information to second color image information that is to be displayed upon the display using the combined color mapping.

2. The device of claim 1, further including an ambient light level sensor configured to measure the level of ambient light, wherein the first input includes a measurement of the level of ambient light from the ambient light level sensor.

3. The device of claim 2, wherein the first color mapping is associated with the level of ambient light being above a first threshold and the second color mapping is associated with the level of ambient light being below a second threshold that is lower than the first threshold.

4. The device of claim 1, wherein the processor is configured to determine the combined color mapping by interpolating between the first color mapping and the second color mapping based at least in part on the first input.

5. The device of claim 1, wherein the first color image information includes an image defined in a device-independent color space, and the second color image information includes the image defined in a color space of the display.

6. The device of claim 2, wherein the processor is further configured to receive at least a second input that is indicative of the level of light provided by the built-in light, wherein the combined color mapping is further based, at least in part, upon the second input, and wherein the first color mapping is associated with a first ambient light level and a first built-in light level, and the second color mapping is associated with a second ambient light level that is different from the first ambient light level and a second built-in light level that is different from the first built-in light level.

7. The device of claim 6, the processor is further configured to calculate the combined color mapping by interpolating between at least the first color mapping, the second color mapping, and a third color mapping,
wherein the first color mapping is associated with a high ambient light level and a low built-in light level, the second color mapping is associated with a high built-in light level and a low ambient light level, and the third color mapping is associated with an intermediate ambient light level and an intermediate built-in light level.

8. The device of claim 7, wherein the display includes a reflective display and the built-in light includes a front light.

9. The device of claim 1, wherein the device includes a mobile telephone, an e-reader, an outdoor sign, a tablet computer, a personal digital assistant, a hand-held or portable computer, a GPS receiver or navigator, a camera, an MP3 player, a camcorder, a game console, a wrist watch, a clock, a calculator, a television monitor, a flat panel display, or a computer monitor.

10. The device of claim 1, wherein the first input includes a measurement of the proportional spectral content of the ambient light.

11. The device of claim 1, wherein the first input includes a measurement of the color temperature of the ambient light.

12. A method for controlling color mapping in a display, the method comprising:
receiving first color image information;
receiving at least a first input that is indicative of a characteristic of the lighting environment of the display;
determining a combined color mapping for rendering colors on the reflective display, wherein the combined color mapping is based, at least in part, upon the first input, a first color mapping, and a second color mapping, the first color mapping being associated with a first lighting environment and the second color mapping being associated with a second lighting environment that is different from the first lighting environment; and
converting the first color image information to second color image information that is to be displayed upon the display using the combined color mapping.

13. The method of claim 12, wherein the first input includes a measurement of the level of ambient light.

14. The method of claim 13, wherein the first color mapping is associated with the level of ambient light being above a first threshold and the second color mapping is associated with the level of ambient light being below a second threshold that is lower than the first threshold.

15. The method of claim 12, wherein determining the combined color mapping includes interpolating between the first color mapping and the second color mapping based at least in part on the first input.

16. The method of claim 12, wherein the first color image information includes an image defined in a device-independent color space, and the second color image information includes the image defined in a color space of the display.

17. The method of claim 12, wherein the display includes a front light configured to provide light to the display, the method further comprising receiving at least a second input that is indicative of the level of light provided by the front light, wherein the combined color mapping is further based, at least in part, upon the second input, and wherein the first color mapping is associated with a first front light level and the second color mapping is associated with a second front light level that is different from the first front light level.

18. The method of claim 12, wherein the first input includes a measurement of the level of ambient light, and wherein the display includes a front light configured to provide light to the display, the method further comprising:
receiving a second input that is indicative of the level of light provided by the front light; and
calculating the combined color mapping by interpolating between at least the first color mapping, the second color mapping, and a third color mapping,
wherein the first color mapping is associated with a high ambient light level and a low front light level, the second color mapping is associated with a high front light level and a low ambient light level, and the third color mapping is associated with an intermediate ambient light level and an intermediate front light level.

19. The method of claim 12, wherein the first input includes a measurement of the proportional spectral content of ambient light.

20. The method of claim 12, wherein the first input includes a measurement of the color temperature of the ambient light.

21. A device comprising:
means for displaying color image information;
light emitting means for providing light for viewing the displaying means; and
processing means for:
receiving first color image information;
receiving at least a first input that is indicative of a characteristic of the lighting environment of the display means;
determining a combined color mapping for rendering colors on the displaying means, wherein the combined color mapping is based, at least in part, upon the first input, a first color mapping, and a second color mapping, the first color mapping being associated with a first lighting environment and the second color mapping being associated with a second lighting environment that is different from the first lighting environment; and
converting the first color image information to second color image information that is to be displayed upon the displaying means using the combined color mapping.

22. The device of claim 21, wherein the displaying means comprises an interferometric modulator display, the light emitting means comprises a front light for the interferometric modulator display, and the processing means comprises a processor.

23. The device of claim 21, further including means for sensing the level of ambient light, wherein the light sensing means includes a color sensor capable of detecting the level of two or more wavelength bands.

24. Non-transitory computer storage including machine-executable instructions that when executed by a processor cause the processor to perform a method for controlling color mapping in a display, the machine-executable instructions including instructions for:
receiving first color image information;
receiving at least a first input that is indicative of a characteristic of the lighting environment of the display;
determining a combined color mapping for rendering colors on the display, wherein the combined color mapping is based, at least in part, upon the first input, a first color mapping, and a second color mapping, the first color mapping being associated with a first lighting environment and the second color mapping being associated with a second lighting environment that is different from the first lighting environment; and
converting the first color image information to second color image information that is to be displayed upon the display using the combined color mapping.

25. The non-transitory computer storage of claim 24, wherein the first input includes a measurement of the level of ambient light, and the first color mapping is associated with the level of ambient light being above a first threshold and the second color mapping is associated with the level of ambient light being below a second threshold that is lower than the first threshold.
